(19) United States
(12) Patent Application Publication
(10) Pub. No.: US 2023/0118934 A1
(43) Pub. Date: Apr. 20, 2023

(54) DYNAMICALLY PERSONALIZED ON-DEMAND TRAINING PLATFORM

(71) Applicant: RPM Fitness, Inc., Campbell, CA (US)

(72) Inventors: Shane Patrick Rogers, Campbell, CA (US); Joshua Barry Rogers, Campbell, CA (US)

(21) Appl. No.: 17/966,166

(22) Filed: Oct. 14, 2022

Related U.S. Application Data
(60) Provisional application No. 63/255,828, filed on Oct. 14, 2021.

(51) Int. Cl. A63B 71/06; G06F 3/0482; G06F 3/0488

(52) U.S. Cl. CPC A63B 71/0616; A63B 71/0669; G06F 3/0482; G06F 3/0488

(57) ABSTRACT

A personalized training system to perform operations that include: receiving a score that corresponds with a content identifier from a user account, the score comprising at least a value that comprises an attribute; accessing a user profile associated with the user account, the user profile indicating a cohort associated with the user account; identifying a set of scores within a leaderboard associated with the content identifier based on the cohort associated with the user account; determining a first ranking of the score associated with the user account among a portion of the set of scores based on at least the attribute of the score; and determining a second ranking of the user account among a subset of the portion of the set of scores based on the value of the score.

### PRIORITY CLAIM

This application claims the benefit of priority of U.S. Provisional Application Ser. No. 63/255,828, filed on Oct. 14, 2021, which is hereby incorporated by reference in its entirety.

### TECHNICAL FIELD

Embodiments of the present disclosure relate generally to the field of on-demand fitness content, and more particularly, but not by way of limitation, to systems and methods to provide dynamically personalized on-demand training content.

### BACKGROUND

On-demand training platforms enable individuals to participate in guided exercise at home and on the individuals own schedule. These platforms can perform various functions such as allowing users to set fitness goals, tracking caloric intake, gathering workout ideas, and sharing progress on social media to facilitate healthy behavior change. While such platforms may promote healthy behavior change through the presentation of workout classes and specially configured hardware components, they lack the intelligence to offer scaling or modification suggestions based on the individual's actual skill level, and instead rely on explicit inputs provided into user preferences.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a block diagram showing an example personalized training system for exchanging data (e.g., training data and associated content) over a network in accordance with some embodiments, wherein the on-demand system includes a personalized training system.

FIG. 2 is a block diagram illustrating various modules of a personalized training system, according to certain example embodiments.

FIG. 3 is a flowchart depicting a method of providing nested rankings within a leaderboard, according to certain example embodiments.

FIG. 4 is a flowchart depicting a method of presenting a menu element, according to certain example embodiments.

FIG. 5 is a flowchart depicting a method of presenting personalizing content, according to certain example embodiments.

FIG. 6 is a flowchart depicting a method of assigning a user account to a cohort based on a score received from the user account, according to certain example embodiments.

FIG. 7 is a flowchart depicting a method of ranking a score within a leaderboard, according to certain example embodiments.

FIGS. 8A and 8B are an interface diagrams depicted various interfaces presented by a personalized training system, according to certain example embodiments.

FIG. 9 is an interface diagram depicted an interface presented by a personalized training system, according to certain example embodiments.

FIG. 10 is an interface diagram depicted an interface presented by a personalized training system, according to certain example embodiments.

FIG. 11 is an interface diagram depicted an interface presented by a personalized training system, according to certain example embodiments.

FIG. 12 is an interface diagram depicted an interface presented by a personalized training system, according to certain example embodiments.

FIG. 13 is an interface diagram depicted an interface presented by a personalized training system, according to certain example embodiments.

FIG. 14 is a block diagram illustrating a representative software architecture, which may be used in conjunction with various hardware architectures herein described and used to implement various embodiments.

FIG. 15 is a block diagram illustrating components of a machine, according to some example embodiments, able to read instructions from a machine-readable medium (e.g., a machine-readable storage medium) and perform any one or more of the methodologies discussed herein.

### DETAILED DESCRIPTION

As discussed above, typical on-demand exercise and training platforms enable individuals to participate in guided exercise classes at home. The existing platforms enable users to access a catalog of workout classes, and in some instances provide functionality to track various metrics in order to rank the user within a leaderboard. Leaderboards provide users with target metrics for themselves to pursue, thereby motivating the user to continue training.

For example, some platforms may provide specially configured hardware to track a predefined set of metrics (i.e., wattage, calories, distance, time) which may be utilized by the system to determine a ranking of the user against similar users, wherein the similarity of other users may be determined based on certain demographic details which may be explicitly provided to the system (e.g., age, sex, gender, location). While these existing leaderboards provide a means of ranking a user's training metrics against other users who share similar demographics information, they fail to account for differences in skill or experience. As a result, the subsequent leaderboard may fail to provide the intended motivating effect.

Furthermore, the existing systems fail to adequately provide users with a means for scaling or modifying training content based on a user's skill or experience, and instead rely on the users of the system themselves to determine appropriate modifications. As a result, some users of the system may make inappropriate modifications or attempt to perform the training content without modification, resulting in an, at best, ineffective training session, and at worst, a potentially harmful training session that may result in injury. Accordingly, example embodiments described herein relate to a system to provide a dynamically personalized on-demand training platform.

For example, in certain example embodiments, a personalized training system may be configured to perform operations that include: receiving a score that corresponds with a content identifier from a user account, the score comprising at least a value that comprises an attribute; accessing a user profile associated with the user account, the user profile indicating a cohort associated with the user account; identifying a set of scores within a leaderboard associated with the content identifier based on the cohort associated with the user account; determining a first ranking of the score associated with the user account among a portion of the set of scores based on at least the attribute of the score; and determining a second ranking of the user account among a subset of the portion of the set of scores based on the value of the score.

Upon determining the first ranking and the second ranking associated with the score, the personalized training system may generate and cause display of a leaderboard, wherein a position of the score associated with the user account among a set of scores may be based upon the first ranking and the second ranking. For example, the personalized training system may present a leaderboard at a client device associated with the user account, wherein a subset of the portion of the set of scores is presented among a plurality of scores based on the first ranking, and wherein the score associated with the user account is presented among the subset based on the second ranking.

In some embodiments, receiving the score may include receiving the score as an input into a menu element presented at a client device associated with the user account. The personalized training system may generate and cause display of a menu element to receive the score, wherein the menu element comprises one or more input fields that may be based on the content identifier. For example, the content identifier may correspond with content, such as a fitness routine or test, wherein a score corresponding to the content may comprise a score type, such as a temporal value, a numerical value, or simply a binary response. Accordingly, the personalized training system may display a menu element that includes one or more input fields based on the score type associated with the content identified by the content identifier.

A user of the personalized training system may provide an input to select the content identifier associated with the content from among a set of content identifiers, and in response, the system may cause display of a presentation of the content at the client device, or at a display communicatively coupled with the client device. Upon determining a completion of the content, or a completion of a training session that corresponds with the content, the personalized training system may generate and cause display of the menu element to receive the score at the client device associated with the user account.

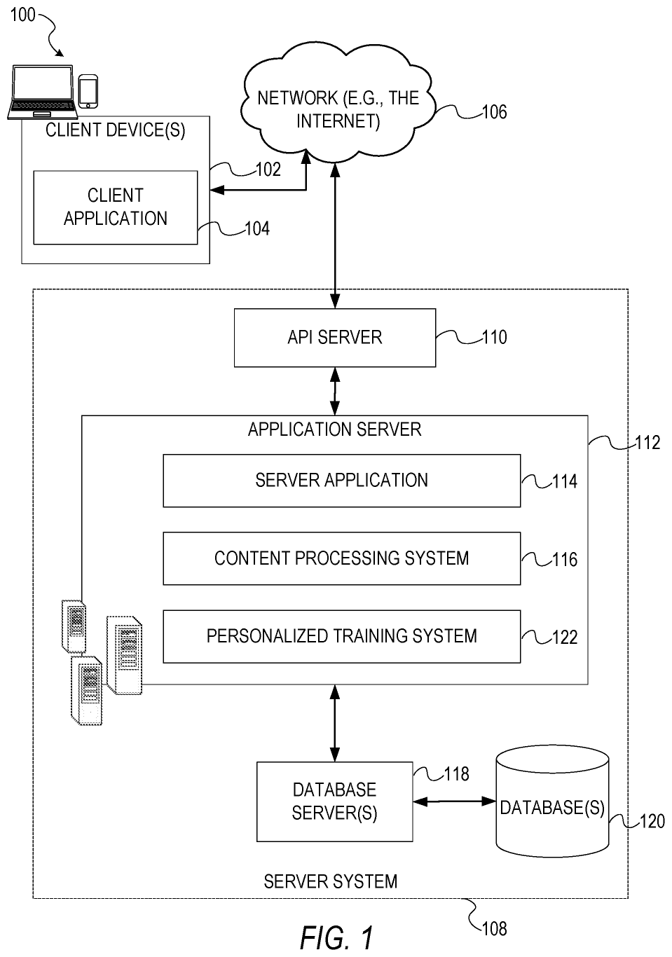

FIG. 1 is a block diagram showing an example dynamically personalized personalized training system 100 for exchanging data (e.g., messages and associated content) over a network. The personalized training system 100 includes one or more client devices 102 which host a number of applications including a client application 104. Each client application 104 is communicatively coupled to other instances of the client application 104 and a server system 108 via a network 106 (e.g., the Internet).

Accordingly, each client application 104 is able to communicate and exchange data with another client application 104 and with the server system 108 via the network 106. The data exchanged between client applications 104, and between a client application 104 and the server system 108, includes functions (e.g., commands to invoke functions) as well as payload data (e.g., text, audio, video or other multimedia data).

The server system 108 provides server-side functionality via the network 106 to a particular client application 104. While certain functions of the personalized training system 100 are described herein as being performed by either a client application 104 or by the server system 108, it will be appreciated that the location of certain functionality either within the client application 104 or the server system 108 is a design choice. For example, it may be technically preferable to initially deploy certain technology and functionality within the server system 108, but to later migrate this technology and functionality to the client application 104 where a client device 102 has a sufficient processing capacity.

The server system 108 supports various services and operations that are provided to the client application 104. Such operations include transmitting data to, receiving data from, and processing data generated by the client application 104. In some embodiments, this data includes, media content, message content, client device information, geolocation information, media annotation, message content persistence conditions, social network information, and live event information, as examples. In other embodiments, other data is used. Data exchanges within the personalized training system 100 are invoked and controlled through functions available via GUIs of the client application 104.

Turning now specifically to the server system 108, an Application Program Interface (API) server 110 is coupled to, and provides a programmatic interface to, an application server 112. The application server 112 is communicatively coupled to a database server 118, which facilitates access to a database 120 in which is stored data associated with content and data processed by the application server 112.

Dealing specifically with the Application Program Interface (API) server 110, this server receives and transmits data (e.g., commands and request payloads) between the client device 102 and the application server 112. Specifically, the Application Program Interface (API) server 110 provides a set of interfaces (e.g., routines and protocols) that can be called or queried by the client application 104 in order to invoke functionality of the application server 112. The Application Program Interface (API) server 110 exposes various functions supported by the application server 112, including account registration, login functionality, the sending of requests and messages, via the application server 112, from a particular client application 104 to another client application 104, the sending of media files (e.g., images or video) from a client application 104 to the server application 114, and for possible access by another client application 104, the setting of a collection of media data (e.g., story), the retrieval of a list of “friends” (i.e., social graph, social media connections, user groups, etc.) of a user of a client device 102, the retrieval of such collections, the retrieval of messages and content, the adding and deletion of friends to a social graph, the location of friends within a social graph, opening and application event (e.g., relating to the messaging client application 104).

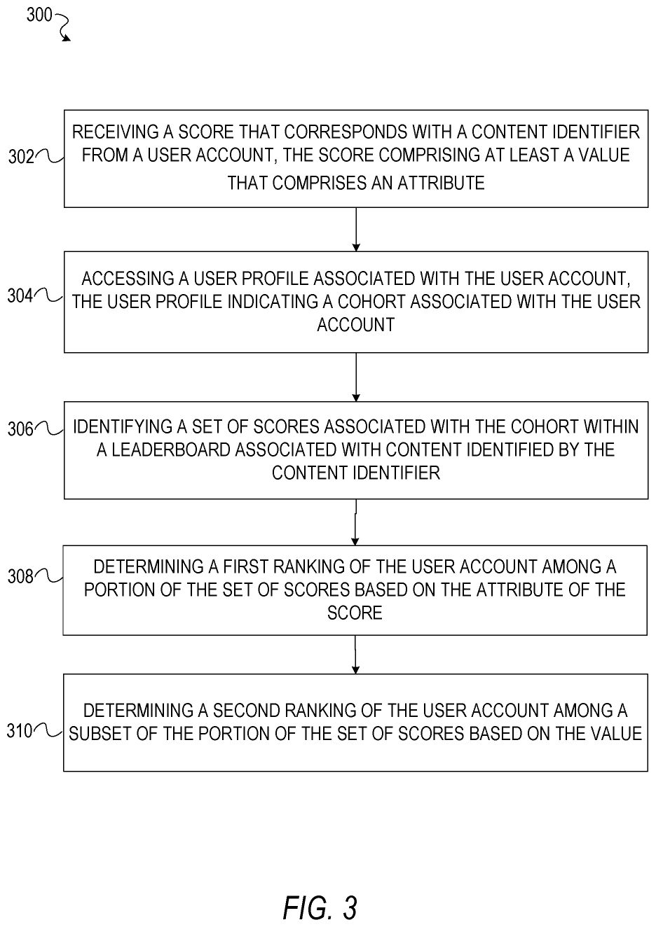

The application server 112 hosts a number of applications and subsystems, including a server application 114, a content processing system 116, and a personalized training system 122. The personalized training system 122 is configured to perform various operations for the dynamically personalized on-demand training platform 100 that may include receiving and transmitting content to and from one or more client devices 102. Further details of the personalized training system 122 can be found in FIG. 3 below.

The server application 114 implements a number of request processing technologies and functions, particularly related to the aggregation and other processing of content (e.g., textual and multimedia content) included in requests received from multiple instances of the client application 104. As will be described in further detail, the text and media content from multiple sources may be aggregated into collections of content. These collections are then made available, by the server application 114, to the client application 104. Other processor and memory intensive processing of data may also be performed server-side by the server application 114, in view of the hardware requirements for such processing.

The application server 112 also includes a content processing system 116 that is dedicated to performing various content processing operations, typically with respect to training content that may comprise images or video received within the payload of a request at the server application 114.

The application server 112 is communicatively coupled to a database server 118, which facilitates access to a database 120 in which is stored data associated with content processed by the content server application 114.

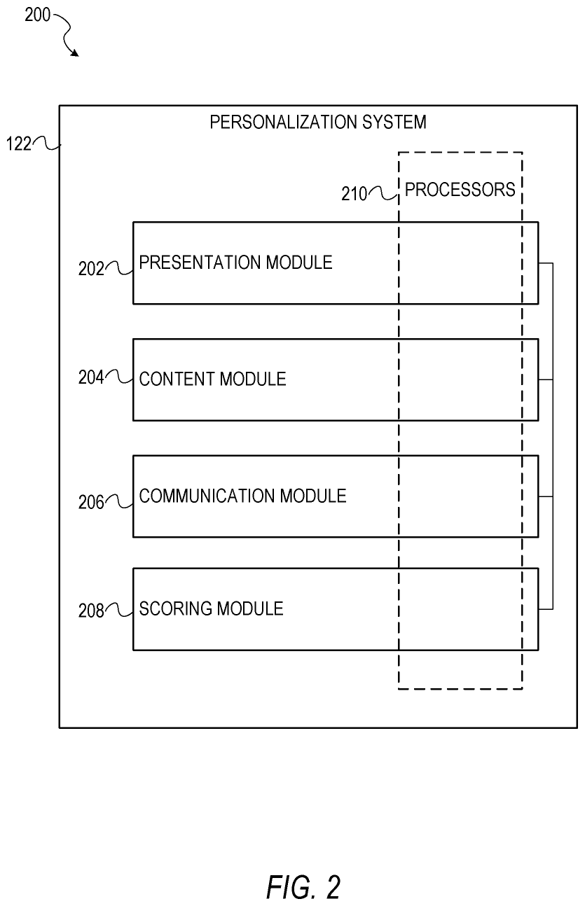

FIG. 2 is a block diagram 200 illustrating components of the personalized training system 122 that configure the personalized training system 122 to provide dynamic personalization of content, according to certain example embodiments.

In some embodiments, the components of the personalized training system 122 may configure the dynamically personalized on-demand training platform to perform operations that include: receiving a score from a user account, the score comprising at least a value that comprises an attribute, and wherein the score represents a performance of a user associated with the user account in performing a training session based on training content, and wherein the training content corresponds with a content identifier; accessing a user profile associated with the user account, the user profile indicating a cohort of the user account; identifying a set of scores within a leaderboard associated with the training content identified by the content identifier, based on the cohort associated with the user account; determining a first ranking of the user account among a portion of the set of scores based on at least the attribute of the score; and determining a second ranking of the user account among a subset of the portion of the set of scores based on the value of the score.

In some embodiments, the components of the personalized training system 122 may configure the dynamically personalized on-demand training platform to perform operations that include: causing display of a presentation of content within a graphical user interface (GUI), the content comprising a feature; determining a conclusion of a training session performed by a user with respect to the content, wherein the conclusion may be determined based on one or more of: biometric data associated with the user, computer vision techniques indicating that the user has stopped moving or has moved from one location to another, the user pressing a button or icon, as well as one or more sensor devices; causing display of a first menu element within the GUI responsive to the conclusion of the content, the first menu element comprising a first property based on at least the feature of the content; receiving an input into the first menu element from the client device, the input comprising a value that comprises an attribute; and causing display of a second menu element within the GUI responsive to the input, the second menu element comprising a second property based on at least the attribute of the value.

In some embodiments, the components of the personalized training system 122 may configure the dynamically personalized on-demand training platform to perform operations that include: receiving a set of ranking indicia from a client device associated with a user account; determining an average score of the user account based on the set of ranking indicia; assigning the user account to a cohort based on the average score; receiving a request to access content from the user account, the content comprising at least an component to be presented at the client device, the component corresponding with a set of elements within a data-table; selecting an element from among the set of elements based on the cohort associated with the user account; and causing display of the component of the content based on the element.

In some embodiments, the components of the personalized training system 122 may configure the dynamically personalized on-demand training platform to perform operations that include: receiving, from a client device associated with a user account, a score to be correlated with content within the user account, the content comprising an element; identifying a plurality of scores that correspond with the element from the user account; calculating a value based on the plurality of scores that correspond with the element; determining a cohort of the user account with respect to the element; and causing display of a notification that includes an identification of the cohort at the client device.

In some embodiments, the components of the personalized training system 122 may configure the dynamically personalized on-demand training platform to perform operations that include: accessing training content that comprises a sequence of components, each component among the sequence of components corresponding with a plurality of options; receiving, from a user account associated with a client device, an input that selects a set of options from among the plurality of options, each option from among the set of options corresponding with a value from among a plurality of values; determining a set of values based on the input that selects the set of options from among the plurality of options; calculating an average based on the set of values; determining a cohort based on the average; receiving a score that corresponds with the training content from the user account associated with the client device; and determining a ranking of the user account within a leaderboard based on the score and the cohort.

The personalized training system 122 is shown as including a presentation module 202, a content module 204, a communication module 206, and a scoring module 208, all configured to communicate with each other (e.g., via a bus, shared memory, or a switch). Any one or more of these modules may be implemented using one or more processors 210 (e.g., by configuring such one or more processors to perform functions described for that module) and hence may include one or more of the processors 210.

Any one or more of the modules described may be implemented using hardware alone (e.g., one or more of the processors 210 of a machine) or a combination of hardware and software. For example, any module described of the personalized training system 122 may physically include an arrangement of one or more of the processors 210 (e.g., a subset of or among the one or more processors of the machine) configured to perform the operations described herein for that module. As another example, any module of the personalized training system 122 may include software, hardware, or both, that configure an arrangement of one or more processors 210 (e.g., among the one or more processors of the machine) to perform the operations described herein for that module. Accordingly, different modules of the personalized training system 122 may include and configure different arrangements of such processors 210 or a single arrangement of such processors 210 at different points in time. Moreover, any two or more modules of the media curation system 124 may be combined into a single module, and the functions described herein for a single module may be subdivided among multiple modules. Furthermore, according to various example embodiments, modules described herein as being implemented within a single machine, database, or device may be distributed across multiple machines, databases, or devices.

FIG. 3 is a flowchart depicting a method 300 of providing nested rankings within a leaderboard, according to certain example embodiments. Operations of the method 300 may be performed by the modules described above with respect to FIG. 2. As shown in FIG. 3, the method 300 includes one or more operations 302, 304, 306, 308, and 310.

Determining a ranking of a user on a leaderboard is often not as simple as comparing individual scores or values. To provide an accurate ranking against peers, other factors must often be considered and weighed appropriately in order to provide a useful assessment to an individual. The disclosed system provides a method of ranking based on a plurality of weighted criteria to determine a ranking of the individual upon a leaderboard, wherein the ranking comprises a nested ranking of the individual.

At operation 302, the score module 208 receives a score that corresponds with a content identifier from a user account, wherein the score comprises a value that includes an attribute.

In some embodiments, receiving the score may include receiving the score as an input into a menu element presented by the presentation module 202 at a client device 100 associated with the user account. The personalized training system 122 may generate and cause display of a menu element to receive the score, wherein the menu element comprises one or more input fields that may be based on the content identifier. For example, the content identifier may correspond with content, such as a fitness routine or test, wherein a score corresponding to the content may comprise a score type, such as a temporal value, a numerical value, or simply a binary response. Accordingly, the presentation module 202 may display a menu element at the client device 100, wherein the menu element includes one or more input fields based on the score type associated with the content identified by the content identifier.

In some embodiments, the presentation module 202 may present the menu element at the client device 100 upon detecting a completion of the content, or a completion of a training session by that corresponds with the content by a user associated with the user account. The personalized training system 122 may generate and cause display of the menu element to receive the score at the client device 100 associated with the user account.

At operation 304, responsive to receiving the score, the scoring module 208 accesses a user profile associated with the user account, wherein the user profile includes an indication of a cohort associated with the user account, wherein the cohort comprises a plurality of user accounts, and wherein each user account among the plurality of user accounts corresponds with a score associated with the content identified by the content identifier. Accordingly, a “cohort” may be defined as a plurality of users that comprise similar fitness assessment scores. A cohort therefore may be associated with a general fitness score across a number of fitness modalities, or in some embodiments may be determined based on a user's fitness score in an individual modality. For example, a user may be associated with a general cohort for use in ranking within a leaderboard or may be associated with a more specific cohort related to individual fitness modalities or elements, such as running, strength training, or other similar elements. A user may therefore be associated with multiple cohorts depending on the type of content being accessed or presented to the user.

Accordingly, at operation 306 the scoring module 208 identifies a set of scores associated with the content from among a leaderboard based on the cohort associated with the user account. At operation 308 the scoring module 208 determines a first ranking associated with the user account based on the attribute associated with the score. For example, in some embodiments the attribute may include a score type associated with the score, such as a temporal value, a numerical value, or a binary response.

As an illustrative example, the content may include a fitness test that includes a time limit. If a user completes the fitness test within the time limit, then the score associated with the user account may comprise a temporal value that indicates how quickly the user was able to complete the fitness test. If the user is unable to complete the fitness test within the time limit, then the score associated with the user account may comprise a numerical value indicating a total number of repetitions which the user completed within the time limit.

Accordingly, the scoring module 208 may determine a first ranking of the user account among a portion of the set of scores based on the attribute of the score, such that users which completed the fitness test within the time limit would be ranked above users who were unable to complete the fitness test within the time limit.

Upon determining the first ranking of the user account among the portion of the set of scores, at operation 310 the scoring module 208 determines a second ranking of the user account among a subset of the portion of the set of scores based on the value associated with the score.

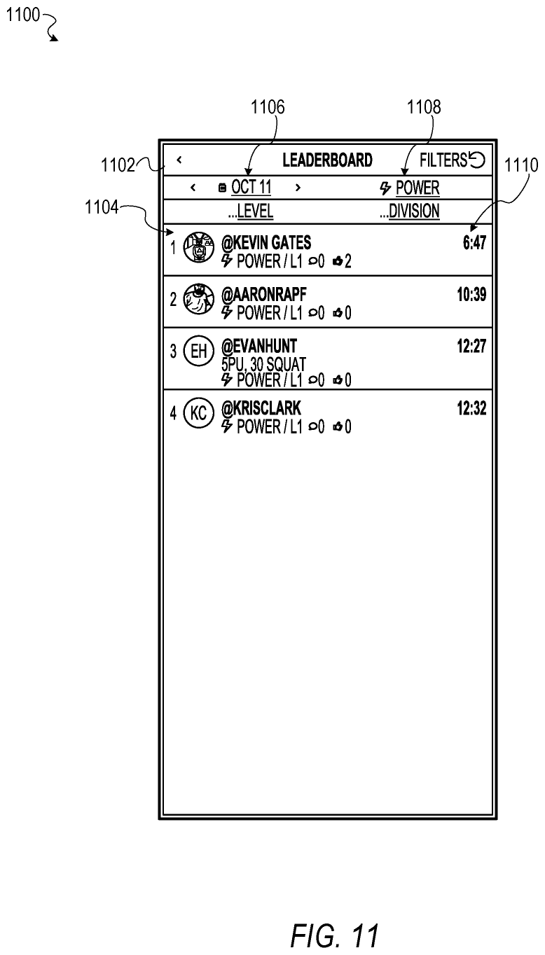

In some embodiments, responsive to the scoring module 208 determining the first ranking and the second ranking, the presentation module 202 may generate and cause display of a leaderboard within a GUI of the client device 100, wherein the leaderboard includes a display of the score associated with the user account at a position among a set of scores based on the first ranking and the second ranking. The interface diagram 1100 depicted in FIG. 11 provides an illustrative example of a leaderboard as discussed herein.

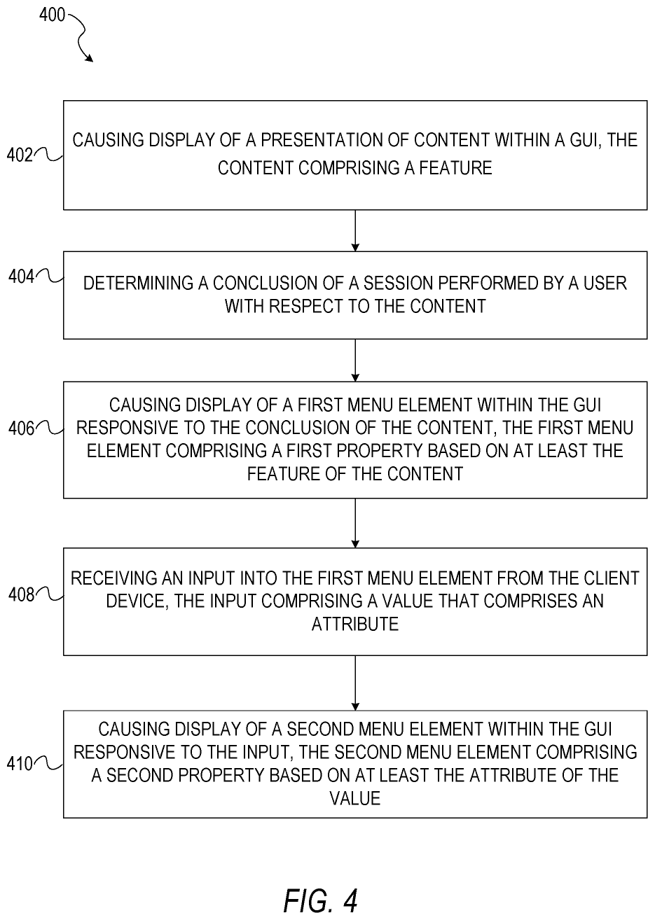

FIG. 4 is a flowchart depicting a method 400 of presenting a dynamic menu element, according to certain example embodiments. Operations of the method 400 may be performed by the modules described above with respect to FIG. 2. As shown in FIG. 4, the method 400 includes one or more operations 402, 404, 406, 408, and 410.

As discussed above with reference to FIG. 3, scores related to content as discussed herein may include different score types. For example, some content presented by the personalized training system 122 may include a score that comprises a single numerical value, while other scores may include a combination of a numerical value and a temporal value, while others may include a binary value indicating a “yes,” or “no.” As a result, the input fields to receive a score from a user performing the content may vary based on attributes and features related to the presented content. Accordingly, a method of presenting a menu element based on attributes or features of displayed content is provided below.

At operation 402, the presentation module 202 generates and causes display of a presentation of content within a GUI of a client device 100, or in some embodiments at a display communicatively coupled with the client device 100, wherein the content corresponds with a feature.

For example, in some embodiments, a user of the client device 100 may provide an input that selects a content identifier associated with the content from among a plurality of content identifiers. Responsive to receiving the input that selects the content identifier, the content module 204 may access a repository, such as the database 120 to retrieve content corresponding with the selected content identifier.

In some embodiments, the feature of the content may include a content type, wherein the content type indicates a type of score associated with the content.

At operation 404, the content module 204 detects a conclusion associated with a training session performed by a user of the client device 100 with respect to the content. For example, the conclusion of the training session may be determined based on an explicit input received from the client device 100, or a conclusion of a time-period associated with the content (e.g., 20 minutes). For example, the content module 204 may receive from the client device 100, an input that selects an icon displayed within the GUI of the client device 100 to indicate a conclusion of a training session.

At operation 406, the presentation module 202 generates and causes display of a first menu element within the GUI of the client device 100 responsive to detecting the conclusion associated with the content, wherein the first menu element comprises a first property that corresponds with the feature of the content. For example, the first property of the first menu element may include an input field that corresponds with a score type associated with the content.

At operation 408, the communication module 206 receives an input via the first menu element from the client device 100, wherein the input comprises a value that comprises an attribute. For example, the attribute of the value may include a score type associated with the value, such as a temporal value, a numerical value, or a binary response.

At operation 410, responsive to receiving the input into the first menu element, the presentation module 202 may generate and cause display of a second menu element within the GUI of the client device 100, wherein the second menu element corresponds with the attribute of the value.

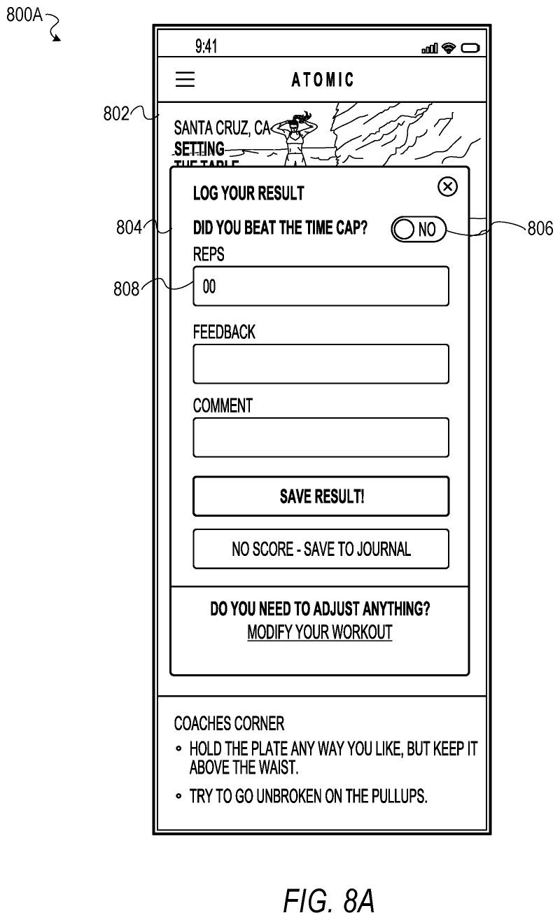

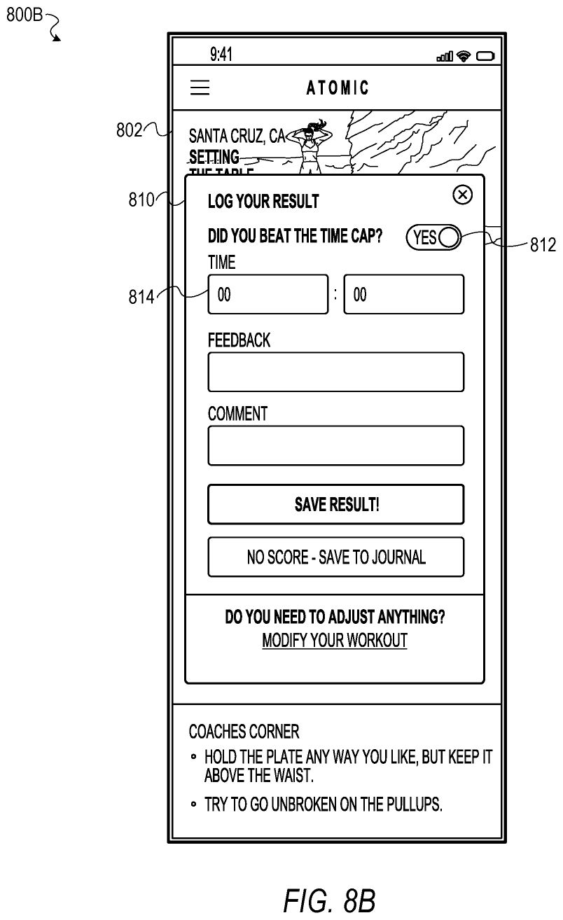

As an illustrative example, the first menu element may be configured to receive a temporal value, while the second menu element may be configured to receive a numerical value. The interface diagram 800 depicted in FIG. 8 provides an illustration of a set of menu elements as described above.

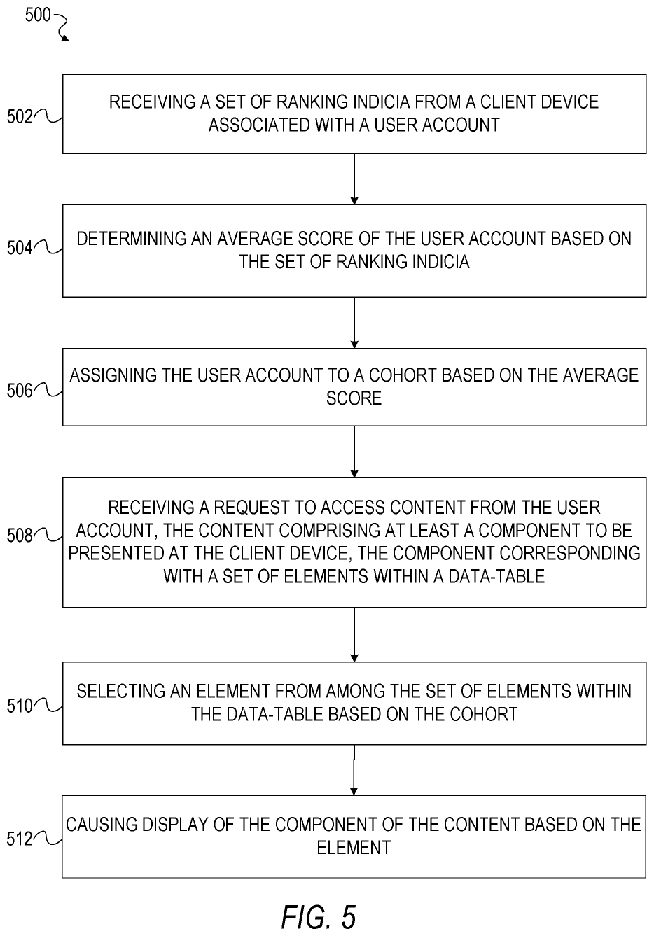

FIG. 5 is a flowchart depicting a method 500 of personalizing on-demand training content, according to certain example embodiments. Operations of the method 500 may be performed by the modules described above with respect to FIG. 2. As shown in FIG. 5, the method 500 includes one or more operations 502, 504, 506, 508, 510, and 512.

According to certain example embodiments, the personalized training system 122 may provide one or more interfaces to enable users of the personalized training system 122 to provide inputs that define various user-attributes and preferences of the user, in order to identify a relevant cohort for purposes of comparison/ranking within a leaderboard. User-attributes may include a user's age, sex, location, and skill level, wherein skill level may be determined based on a user's self-reported proficiency or ability to perform a set of movements or actions. For example, the personalized training system 122 may provide a selection of user-selectable icons in order to determine what a user is or is not capable of performing and may thereby utilize the user's response in assessing skill level.

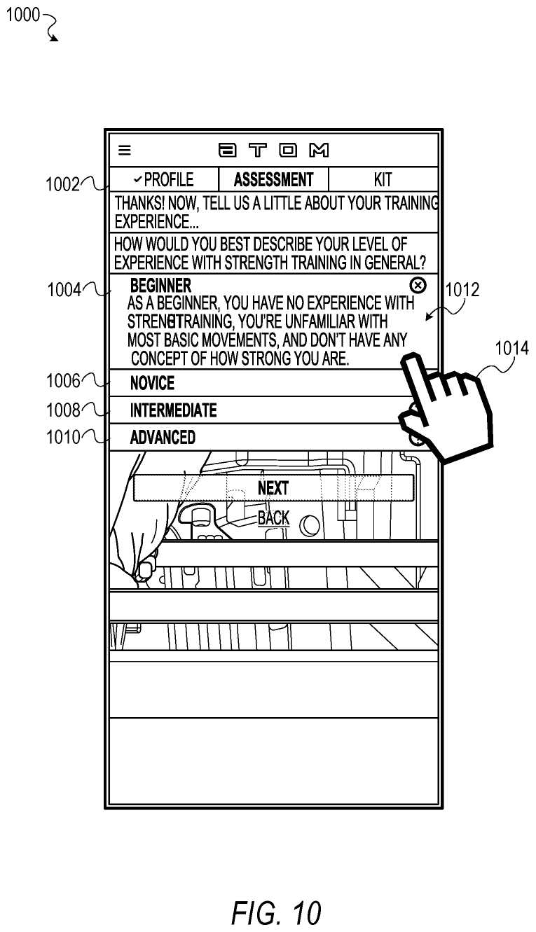

At operation 502, the scoring module 208 receives a set of ranking indicia from a client device 100, wherein the client device 100 may be associated with a user account. For example, the presentation module may generate and cause display of one or more interfaces to receive the set of ranking indicia from the client device 100. Ranking indicia may include a user's age, height, weight, gender, location, as well as a number of self-reported indicia related to a user's proficiency in performing certain movements (e.g., running, push-ups, pull-ups, snatch, etc.). The interface diagram 1000 of FIG. 10 provides an illustrative example of an interface to receive ranking indicia.

At operation 504, the scoring module 208 determines an average score based on the set of ranking indicia and associates the average score with the user account.

At operation 506, the scoring module 208 identifies a cohort based on the determined average score, wherein the cohort comprises one or more “similar” user's, wherein the similarity may be based upon corresponding average scores.

At operation 508, the user may provide an input to select a content identifier from among a set of content identifiers, wherein the content comprises a component to be presented at the client device 100, wherein the component corresponds with a set of elements within a data-table within the database 120.

For example, the component may include a component or part of a fitness routine, wherein the fitness routine comprises one or more components, and wherein each element among the set of elements may correspond with an option for the component. In some embodiments, each element among the set of elements may correspond with a distinct cohort, such that a user's cohort may be utilized to select an appropriate option for the component.

As an illustrative example, the component may correspond with a set of options that include: rowing for 20 calories on a stationary rower; biking for 20 calories on a stationary bike; completing 50 squats; or running 100 m, wherein an option from among the set of options may be selected for the user based on their corresponding cohort. Accordingly, at operation 510, the content module 204 may select an option from among the set of options based on the cohort of the user.

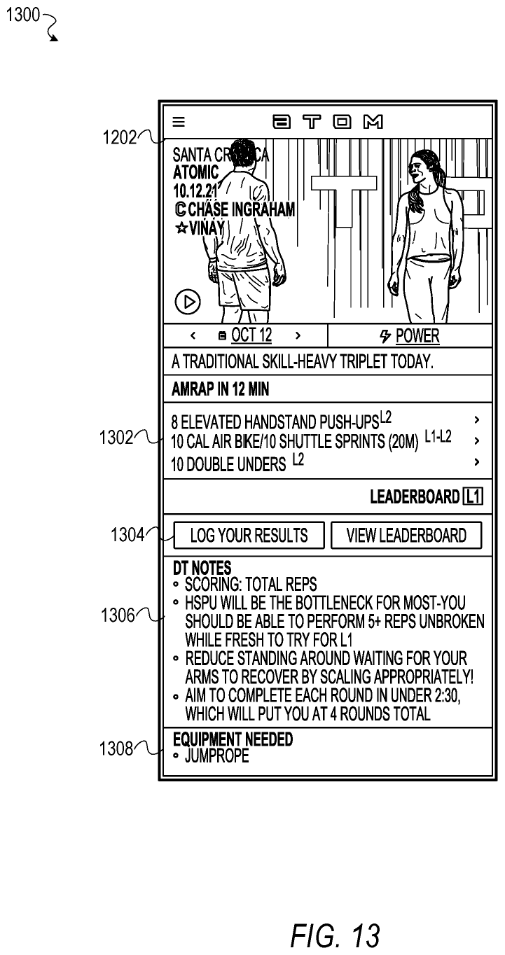

At operation 512, the presentation module 202 generates causes display of a presentation of the component at the client device 100 based on the selected element. The interface diagram 1300 depicted in FIG. 13 provides an illustrative example of content presented based on a user's cohort.

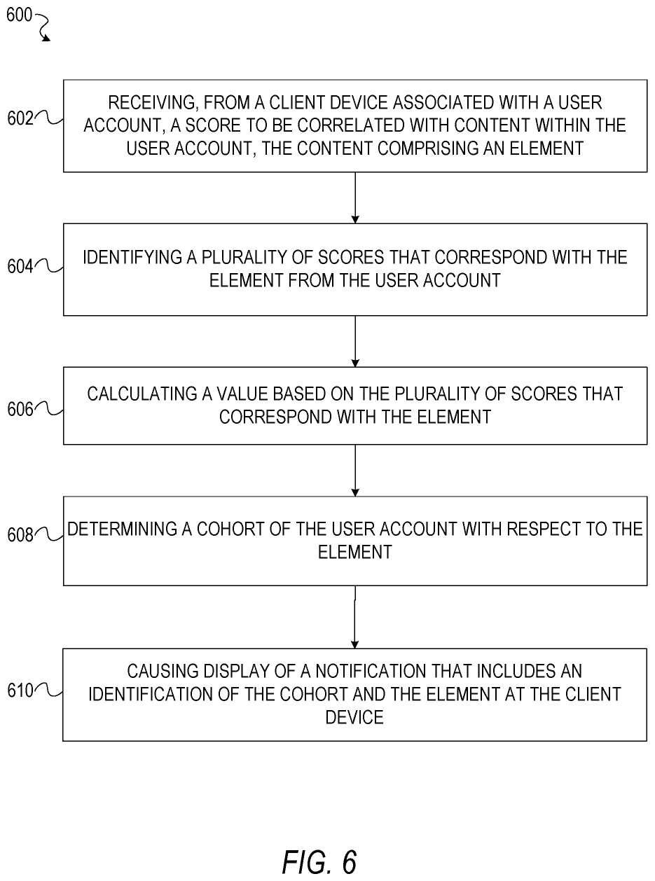

FIG. 6 is a flowchart depicting a method 600 of assigning a user account to a cohort based on a score received from the user account, according to certain example embodiments. Operations of the method 600 may be performed by the modules described above with respect to FIG. 2. As shown in FIG. 6, the method 600 includes one or more operations 602, 604, 606, 608, and 610.

According to certain example embodiments, the personalized training system 122 may perform operations to receive user inputs that define various user-attributes and preferences, in order to identify a user's peers for purposes of comparison/ranking within a leaderboard.

At operation 602, the scoring module 208 receives a score from a client device 100, wherein the score is to be correlated with content, wherein the content comprises an element.

For example, as discussed in the method 400 depicted in FIG. 4, upon completing the content, the presentation module 202 may present one or more menu elements to receive a score to be correlated with the content. Similarly, a user may provide an input to select a content identifier that identifies the content in order to be presented with a menu element to log a score associated with the content. For example, the interface diagram 800 of FIG. 8 provides an illustrative example of a menu element to receive a score to be correlated with content.

At operation 604, the scoring module 208 identifies a plurality of scores that correspond with the element from the user account. For example, the user associated with the user account may have previously completed content that included similar elements. As an illustrative example, the element may include a fitness movement, such as a back-squat, timed run, or row. The user may have previously recorded scores related to the element based on past content.

At operation 606, the scoring module 208 calculates a value based on the plurality of scores that correspond with the element. For example, the value may include an average value, or a median value. The value may therefore represent a user's proficiency or skill level with relation to the element.

At operation 608, the scoring module 208 identifies a cohort of users from among a plurality of users based on the value corresponding with the element.

At operation 610, the presentation module 202 generates and causes display of a notification at the client device 100, wherein the notification includes an identification of the cohort and the element. The identification of the cohort may include a display of one or more user identifiers, as well as attributes associated with the users that make up the cohort. As an illustrative example, the notification may provide an indication that the user's performance with respect to the element is comparable to the one or more users associated with the identified cohort.

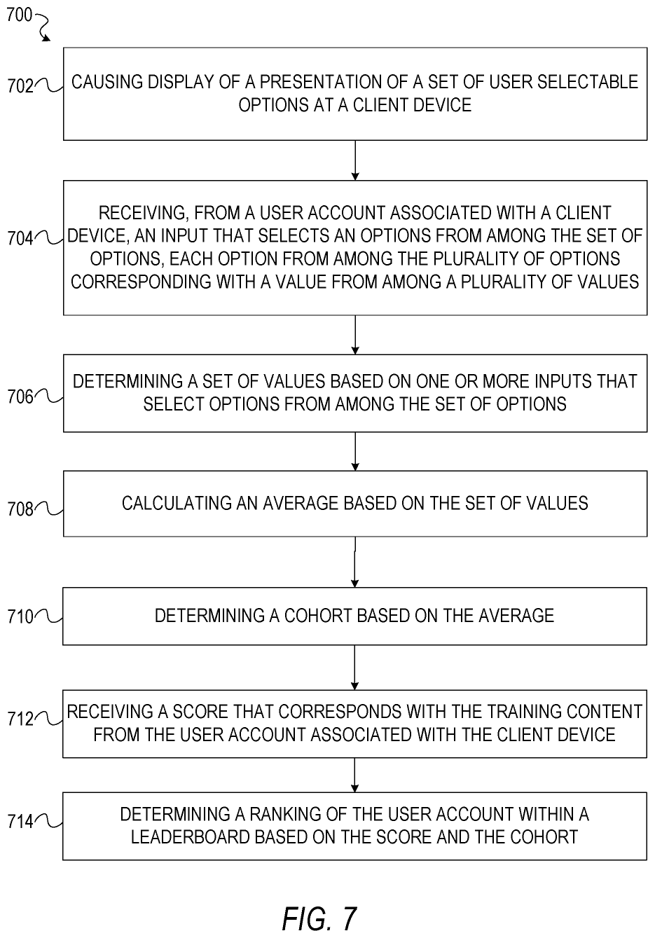

FIG. 7 is a flowchart depicting a method 700 for determining a ranking of a score within a global leaderboard based on an average value, according to certain example embodiments. Operations of the method 700 may be performed by the modules described above with respect to FIG. 2. As shown in FIG. 7, the method 700 includes one or more operations 702, 704, 706, 708, 710, 712, and 714.

At operation 702, the presentation module 202 may generate and cause display of a set of user selectable options at a client device 100, wherein each option among the set of user selectable options may represent a skill level for a given fitness component, from beginner to advanced. For example, the options may correspond with a user's ability to perform certain movements or tasks for purposes in assessing a user's athletic skill.

Accordingly, at operation 704, the content module 204 receives an input from a user account associated with the client device 100, wherein the input selects an option from among the set of options associated with each given component.

As an illustrative example, each component may correspond with an option, wherein each option represents a skill level which may be defined for a given movement. For example, a component may represent a movement such as a “handstand push-up.” The options for the handstand push-up may thereby go from most advanced, which would be a full handstand push-up, while an intermediate option may include a “box push-up,” and a beginner option may include a basic push-up. Accordingly, each options among the set of options may correspond with a value, such that the most advanced option corresponds with a value of 3, the intermediate option corresponds with a value of 2, and the beginner option corresponds with a value of 1.

At operation 706, the scoring module 208 determines a set of values based on a set of inputs received from the user account. For example, the user may provide inputs that select options from among a set of options associated with each component.

At operation 708, the scoring module 208 calculates an average score based on the selected options, and at operation 710, determines a cohort to assign the user account to based on the average. For example, each cohort among the set of cohorts may correspond with a skill level from beginner to advanced, and wherein each skill level may correspond with a value.

At operation 712, having assigned the user to a cohort, the scoring module 208 may receive a score from the user account, wherein the score corresponds with content, such as fitness content.

At operation 714, the scoring module 208 determines a ranking of the user within a leaderboard comprising a plurality of users from the same cohort associated with the user account.

FIG. 8A and FIG. 8B are interface diagrams 800A and 800B depicting interfaces presented by personalized training system 122, according to certain example embodiments.

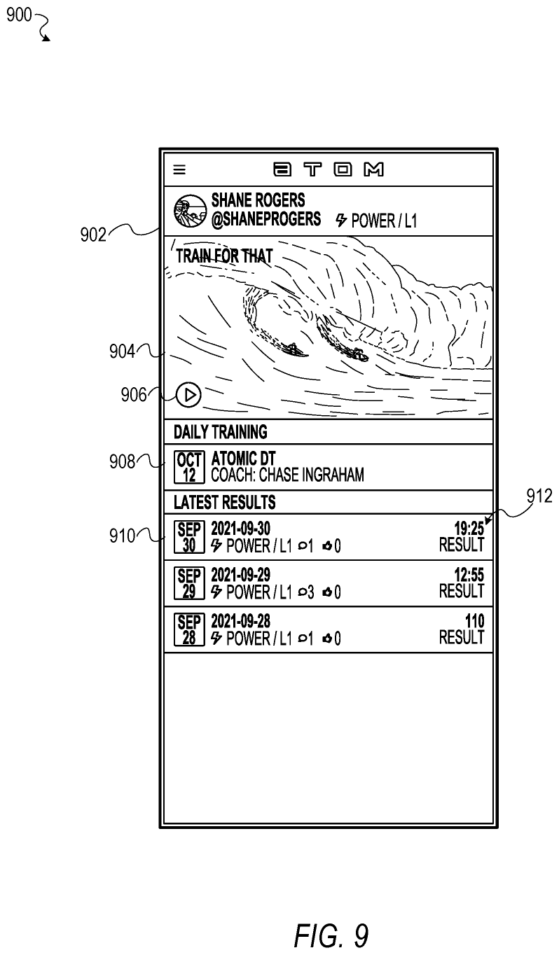

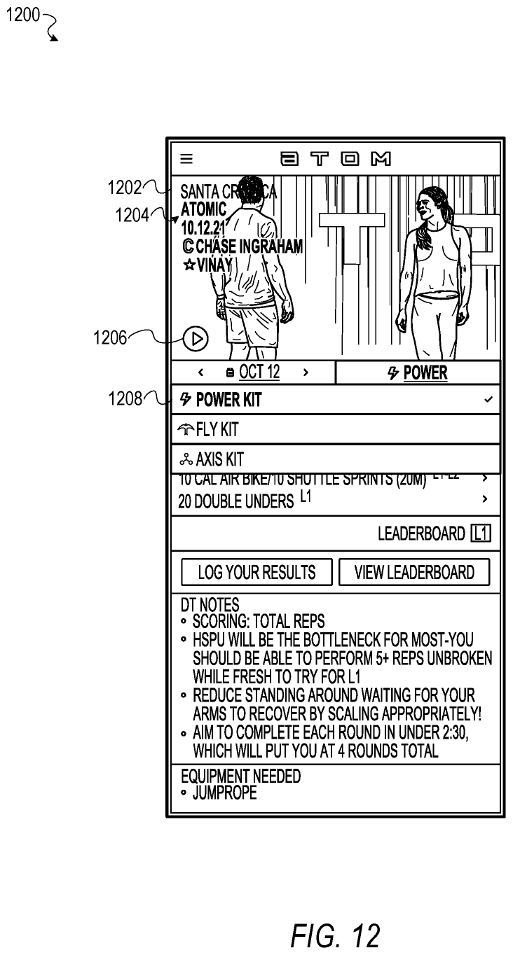

As seen in the interface diagram 800A, the personalized training system 122 may generate and cause display of an interface 802 to display training content, such as: the training content 904 depicted in the interface 902 of FIG. 9; and the training content 1204 depicted in the interface 1200 of FIG. 12.

In some embodiments, as described in the method 400 of FIG. 4, responsive to detecting a conclusion of the training content presented within the interface 802, or based on an input that selects an icon, such as the icon 1304 depicted in FIG. 13, the personalized training system 122 may generate and cause display of a menu element 804, wherein the menu element 804 comprises one or more input fields 806 and 808 to receive inputs from a user of the client device 100.

In some embodiments, attributes of the input field 808 may be based upon the training content presented within the interface 802. For example, a score associated with the training content may be based on a total time to complete the training content, or in some embodiments may be based upon an amount of work completed (i.e., reps completed) within an allotted time. Accordingly, the personalized training system 122 may display the input field 808 based on attributes of the training content presented within the interface 802.

In some embodiments, attributes of the input field 808 may be based upon attributes of the user's score. For example, a user may provide an input to select the input field 806, wherein the input field 806 indicates whether or not the user was able to complete the training content within an allotted time associated with the training content. Accordingly, if the user was able to complete the training content within the allotted time, the input field 808 may be configured to receive a temporal value indicating a total time required, whereas if the user was unable to complete the training content within the allotted time, the input field 808 may be configured to receive a numerical value, as depicted in the interface diagram 800B. As seen in the interface diagram 800B the input field 814 presented within the menu element 810 may be based upon attributes of the training content presented in the interface 802.

FIG. 9 is an interface diagram 900 depicted an interface presented by a personalized training system 122, according to certain example embodiments. As seen in the interface diagram 900, the personalized training system 122 may generate and cause display of an interface 902, wherein the interface 902 comprises a display of training content 904.

In some embodiments, a listing of content identifiers may be presented at a position within the interface 902, such as the content identifier 908. Accordingly, responsive to receiving an input that selects a content identifier, such as the content identifier 908, the personalized training system may cause display of corresponding training content within the interface 902.

In some embodiments, the listing of content identifiers may also include a display of a score, such as the score 912, wherein the score corresponds with an entry provided by a user of the user account with respect to the associated content identifier. As an illustrative example, the score 912 represents a score input by a user of the client device 100 with respect to training content associated with the content identifier 910.

FIG. 10 is an interface diagram 1000 depicted an interface 1002 presented by a personalized training system 122, according to certain example embodiments. According to certain example embodiments, the interface 1002 may include an interface to enable a user to provide inputs to determine a skill level of the user, to determine an appropriate cohort for the user, as described in the method 500 depicted in FIG. 5.

For example, as seen in the interface 1002, the personalized training system 122 may cause display of a set of icons 1004, 1006, 1008, and 1010, wherein each icon corresponds with a user selectable option related to a user's fitness assessment. In some embodiments, each icon among the set of icons may correspond with a value, wherein a set of values may be scored or otherwise averaged, as described in the method 500.

In some embodiments, a user may provide an input 1014 to select an icon, such as the icon 1004, in order to be presented with additional information 1014 related to the selected option. In some embodiments, the additional information 1014 may include text content, as depicted in the interface diagram 1000, while in some embodiments, the additional information may include media content, such as a video.

FIG. 11 is an interface diagram 1100 depicted an interface 1102 presented by a personalized training system 122, according to certain example embodiments. As seen in the interface 1102, the personalized training system 122 may generate and cause display of a leaderboard 1104 based on user attributes associated with a user account, wherein the user attributes define a cohort associated with the user.

According to certain embodiments, a user's cohort may be determined based on user provided inputs that select one or more options presented to the user, such as the options presented in the interface 1000 of FIG. 10, or in some embodiments may be determined on the fly based on a user's historical scores. Accordingly, a user may be associated with multiple different cohorts based on the content being accessed or requested by the user. For example, a user may request to be presented with a leaderboard associated with fitness content, or in some embodiments may request to be presented with a leaderboard associated with individual fitness metrics.

As seen in the interface 1102, the leaderboard 1104 may include a menu to display content attributes 1106 and 1108, wherein the scores 1110 may correspond with the selected content attributes. Accordingly, the scores 1110 may correspond with fitness content originally distributed on October 11 which corresponds with the content identifier 1108.

FIG. 12 is an interface diagram 1200 depicted an interface 1202 to present training content, according to certain example embodiments. As seen in the interface diagram 1200, the interface 1202 may include a display of training content 1204, wherein the display of the training content includes a content identifier (i.e., “ATOMIC”), as well as an icon 1206 to access and display the content.

In some embodiments, a user may provide an input to select a menu option 1208 from among a set of menu options, wherein the menu option 1208 corresponds with a set of options associated with the training content 1202. For example, the menu option 1208 may provide an indication of equipment which is available to the user, such that the training content presented within the interface 1202 may be modified based on the user's available equipment.

Accordingly, FIG. 13 provides an interface diagram 1300 depicting how a presentation of the training content 1202 may be modified based on a selected option from among the set of menu options 1208, according to certain example embodiments.

For example, the interface 1202 may include a training menu 1302, wherein elements presented within the training menu 1302 may be based upon the menu option 1208 and the training content 1204, training notes 1306, wherein the training notes 1306 may be based on the training content 1204. In some embodiments, the interface 1202 may also include an equipment menu 1308, wherein the equipment menu 1308 is based on the training content 1204 and a selected menu option, such as the menu option 1208. A user may provide an input to select the icon 1304 in order to be presented with a menu element to log a score, such as the menu element 804 or the menu element 810, presented in FIGS. 8A and 8B.

### Software Architecture

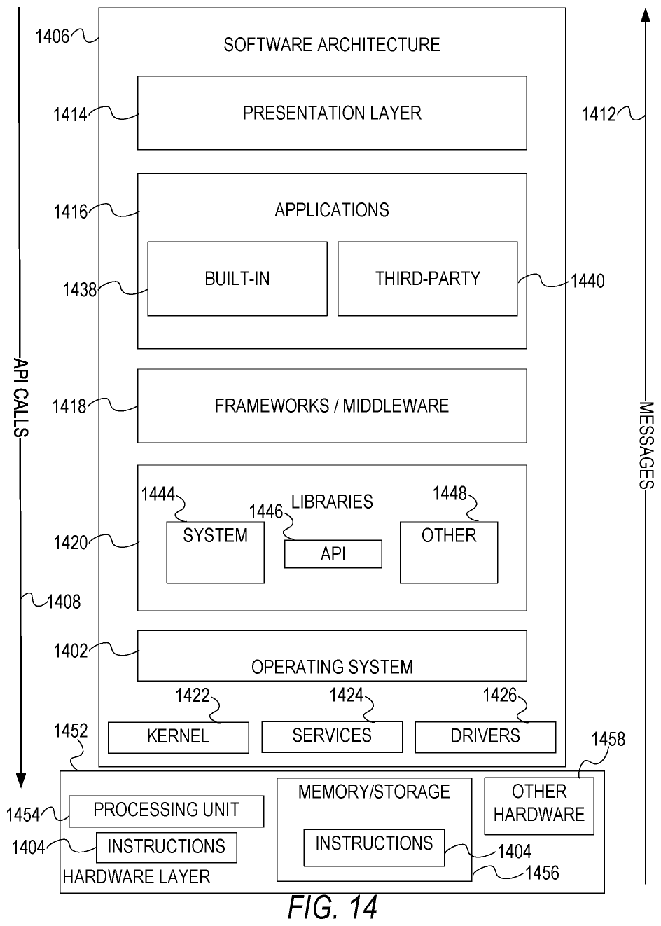

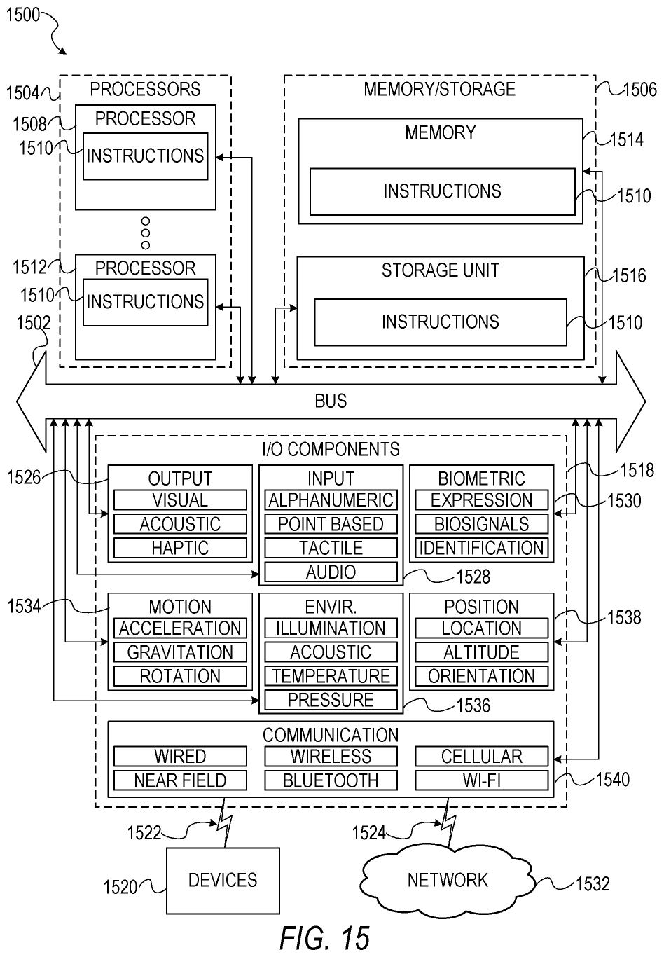

FIG. 14 is a block diagram illustrating an example software architecture 1406, which may be used in conjunction with various hardware architectures herein described. FIG. 14 is a non-limiting example of a software architecture and it will be appreciated that many other architectures may be implemented to facilitate the functionality described herein. The software architecture 1406 may execute on hardware such as machine 1500 of FIG. 15 that includes, among other things, processors 1504, memory 1514, and I/O components 1518. A representative hardware layer 1452 is illustrated and can represent, for example, the machine 1400 of FIG. 14. The representative hardware layer 1452 includes a processing unit 1454 having associated executable instructions 1404. Executable instructions 1404 represent the executable instructions of the software architecture 1406, including implementation of the methods, components and so forth described herein. The hardware layer 1452 also includes memory and/or storage modules memory/storage 1456, which also have executable instructions 1404. The hardware layer 1452 may also comprise other hardware 1458.

In the example architecture of FIG. 14, the software architecture 1406 may be conceptualized as a stack of layers where each layer provides particular functionality. For example, the software architecture 1406 may include layers such as an operating system 1402, libraries 1420, applications 1416 and a presentation layer 1414. Operationally, the applications 1416 and/or other components within the layers may invoke application programming interface (API) API calls 1408 through the software stack and receive a response as in response to the API calls 1408. The layers illustrated are representative in nature and not all software architectures have all layers. For example, some mobile or special purpose operating systems may not provide a frameworks/middleware 1418, while others may provide such a layer. Other software architectures may include additional or different layers.

The operating system 1402 may manage hardware resources and provide common services. The operating system 1402 may include, for example, a kernel 1422, services 1424 and drivers 1426. The kernel 1422 may act as an abstraction layer between the hardware and the other software layers. For example, the kernel 1422 may be responsible for memory management, processor management (e.g., scheduling), component management, networking, security settings, and so on. The services 1424 may provide other common services for the other software layers. The drivers 1426 are responsible for controlling or interfacing with the underlying hardware. For instance, the drivers 1426 include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 1420 provide a common infrastructure that is used by the applications 1416 and/or other components and/or layers. The libraries 1420 provide functionality that allows other software components to perform tasks in an easier fashion than to interface directly with the underlying operating system 1402 functionality (e.g., kernel 1422, services 1424 and/or drivers 1426). The libraries 1420 may include system libraries 1444 (e.g., C standard library) that may provide functions such as memory allocation functions, string manipulation functions, mathematical functions, and the like. In addition, the libraries 1420 may include API libraries 1446 such as media libraries (e.g., libraries to support presentation and manipulation of various media format such as MPREG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 1420 may also include a wide variety of other libraries 1448 to provide many other APIs to the applications 1416 and other software components/modules.

The frameworks/middleware 1418 (also sometimes referred to as middleware) provide a higher-level common infrastructure that may be used by the applications 1416 and/or other software components/modules. For example, the frameworks/middleware 1418 may provide various graphic user interface (GUI) functions, high-level resource management, high-level location services, and so forth. The frameworks/middleware 1418 may provide a broad spectrum of other APIs that may be utilized by the applications 1416 and/or other software components/modules, some of which may be specific to a particular operating system 1402 or platform.

The applications 1416 include built-in applications 1438 and/or third-party applications 1440. Examples of representative built-in applications 1438 may include, but are not limited to, a contacts application, a browser application, a book reader application, a location application, a media application, a messaging application, and/or a game application. Third-party applications 1440 may include an application developed using the ANDROID™ or IOS™ software development kit (SDK) by an entity other than the vendor of the particular platform, and may be mobile software running on a mobile operating system such as IOS™, ANDROID™, WINDOWS® Phone, or other mobile operating systems. The third-party applications 1440 may invoke the API calls 1408 provided by the mobile operating system (such as operating system 1402) to facilitate functionality described herein.

The applications 1416 may use built in operating system functions (e.g., kernel 1422, services 1424 and/or drivers 1426), libraries 1420, and frameworks/middleware 1418 to create user interfaces to interact with users of the system. Alternatively, or additionally, in some systems interactions with a user may occur through a presentation layer, such as presentation layer 1414. In these systems, the application/component “logic” can be separated from the aspects of the application/component that interact with a user.

FIG. 15 is a block diagram illustrating components of a machine 1400, according to some example embodiments, able to read instructions from a machine-readable medium (e.g., a machine-readable storage medium) and perform any one or more of the methodologies discussed herein. Specifically, FIG. 15 shows a diagrammatic representation of the machine 1500 in the example form of a computer system, within which instructions 1510 (e.g., software, a program, an application, an applet, an app, or other executable code) for causing the machine 1500 to perform any one or more of the methodologies discussed herein may be executed. As such, the instructions 1510 may be used to implement modules or components described herein. The instructions 1510 transform the general, non-programmed machine 1500 into a particular machine 1500 programmed to carry out the described and illustrated functions in the manner described. In alternative embodiments, the machine 1500 operates as a standalone device or may be coupled (e.g., networked) to other machines. In a networked deployment, the machine 1500 may operate in the capacity of a server machine or a client machine in a server-client network environment, or as a peer machine in a peer-to-peer (or distributed) network environment. The machine 1500 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1510, sequentially or otherwise, that specify actions to be taken by machine 1500. Further, while only a single machine 1500 is illustrated, the term “machine” shall also be taken to include a collection of machines that individually or jointly execute the instructions 1510 to perform any one or more of the methodologies discussed herein.

The machine 1500 may include processors 1504, memory memory/storage 1506, and I/O components 1518, which may be configured to communicate with each other such as via a bus 1502. The memory/storage 1506 may include a memory 1514, such as a main memory, or other memory storage, and a storage unit 1516, both accessible to the processors 1504 such as via the bus 1502. The storage unit 1516 and memory 1514 store the instructions 1510 embodying any one or more of the methodologies or functions described herein. The instructions 1510 may also reside, completely or partially, within the memory 1514, within the storage unit 1516, within at least one of the processors 1504 (e.g., within the processor's cache memory), or any suitable combination thereof, during execution thereof by the machine 1500. Accordingly, the memory 1514, the storage unit 1516, and the memory of processors 1504 are examples of machine-readable media.

The I/O components 1518 may include a wide variety of components to receive input, provide output, produce output, transmit information, exchange information, capture measurements, and so on. The specific I/O components 1518 that are included in a particular machine 1500 will depend on the type of machine. For example, portable machines such as mobile phones will likely include a touch input device or other such input mechanisms, while a headless server machine will likely not include such a touch input device. It will be appreciated that the I/O components 1518 may include many other components that are not shown in FIG. 15. The I/O components 1518 are grouped according to functionality merely for simplifying the following discussion and the grouping is in no way limiting. In various example embodiments, the I/O components 1518 may include output components 1526 and input components 1528. The output components 1526 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1528 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 1518 may include biometric components 1530, motion components 1534, environmental environment components 1536, or position components 1538 among a wide array of other components. For example, the biometric components 1530 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 1534 may include acceleration sensor components (e.g., accelerometer), gravitation sensor components, rotation sensor components (e.g., gyroscope), and so forth. The environment components 1536 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1538 may include location sensor components (e.g., a Global Position system (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1518 may include communication components 1540 operable to couple the machine 1500 to a network 1532 or devices 1520 via coupling 1522 and coupling 1524 respectively. For example, the communication components 1540 may include a network interface component or other suitable device to interface with the network 1532. In further examples, communication components 1540 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1520 may be another machine or any of a wide variety of peripheral devices (e.g., a peripheral device coupled via a Universal Serial Bus (USB)).

Moreover, the communication components 1540 may detect identifiers or include components operable to detect identifiers. For example, the communication components 1540 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1540, such as, location via Internet Protocol (IP) geo-location, location via Wi-Fi® signal triangulation, location via detecting a NFC beacon signal that may indicate a particular location, and so forth.

### Glossary

“CARRIER SIGNAL” in this context refers to any intangible medium that is capable of storing, encoding, or carrying instructions for execution by the machine, and includes digital or analog communications signals or other intangible medium to facilitate communication of such instructions. Instructions may be transmitted or received over the network using a transmission medium via a network interface device and using any one of a number of well-known transfer protocols.

“CLIENT DEVICE” in this context refers to any machine that interfaces to a communications network to obtain resources from one or more server systems or other client devices. A client device may be, but is not limited to, a mobile phone, desktop computer, laptop, portable digital assistants (PDAs), smart phones, tablets, ultra books, netbooks, laptops, multi-processor systems, microprocessor-based or programmable consumer electronics, game consoles, set-top boxes, or any other communication device that a user may use to access a network.

“COMMUNICATIONS NETWORK” in this context refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network and the coupling may be a Code Division Multiple Access (CDMA) connection, a Global System for Mobile communications (GSM) connection, or other type of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

“MACHINE-READABLE MEDIUM” in this context refers to a component, device or other tangible media able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions (e.g., code) for execution by a machine, such that the instructions, when executed by one or more processors of the machine, cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

“COMPONENT” in this context refers to a device, physical entity or logic having boundaries defined by function or subroutine calls, branch points, application program interfaces (APIs), or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a Field-Programmable Gate Array (FPGA) or an Application Specific Integrated Circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software) may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)). The performance of certain of the operations may be distributed among the processors, not only residing within a single machine, but deployed across a number of machines. In some example embodiments, the processors or processor-implemented components may be located in a single geographic location (e.g., within a home environment, an office environment, or a server farm). In other example embodiments, the processors or processor-implemented components may be distributed across a number of geographic locations. In some embodiments a component may additionally refer to a part of training content presented by an personalized training system. For example, the training content may comprise a listing of components, wherein each component may comprise a combination of physical movements, repetitions, exercise equipment, and so on.

“PROCESSOR” in this context refers to any circuit or virtual circuit (a physical circuit emulated by logic executing on an actual processor) that manipulates data values according to control signals (e.g., “commands”, “op codes”, “machine code”, etc.) and which produces corresponding output signals that are applied to operate a machine. A processor may, for example, be a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC) or any combination thereof. A processor may further be a multi-core processor having two or more independent processors (sometimes referred to as “cores”) that may execute instructions contemporaneously.

“TIMESTAMP” in this context refers to a sequence of characters or encoded information identifying when a certain event occurred, for example giving date and time of day, sometimes accurate to a small fraction of a second.

What is claimed is:

1. A system comprising:
a memory; and
at least one hardware processor; and
one or more processors that cause the system to perform operations comprising:
receiving a score that corresponds with a content identifier from a user account, the score comprising at least a value that comprises an attribute;
accessing a user profile associated with the user account, the user profile indicating a cohort associated with the user account;
identifying a set of scores within a leaderboard associated with the content identifier based on the cohort associated with the user account;
determining a first ranking of the score associated with the user account among a portion of the set of scores based on at least the attribute of the score; and
determining a second ranking of the user account among a subset of the portion of the set of scores based on the value of the score.

2. The system of claim 1, further comprising:
causing display of a presentation of an identifier associated with the user account based on the first ranking and the second ranking.

3. The system of claim 2, wherein the presentation of the identifier based on the first ranking and the second ranking includes a display of the subset of the set of scores at a first position among the set of scores based on the first ranking, and wherein the identifier is presented at a second position among the subset of the portion of the set of scores based on the second ranking.

4. The system of claim 1, wherein the receiving the score includes:
receiving an input from a client device associated with the user account, wherein the input comprises the score.

5. The system of claim 1, wherein the value includes a numerical value, and wherein the attribute includes a temporal value.

6. The system of claim 1, wherein the receiving the score includes:
receiving a selection of the content identifier from among a set of content identifiers;
causing display of an input field to receive the input responsive to the selection of the content identifier; and
receiving an input that comprises the score via the input field.

7. The system of claim 6, wherein the input field is selected from among a plurality of input fields based on the content identifier.

8. The system of claim 1, wherein the accessing the user profile that indicates the cohort associated with the user account includes:
receiving a set of ranking indicia from a client device associated with the user account; and
assigning the user account to the cohort based on the ranking indicia.

9. The system of claim 1, wherein the receiving the score that corresponds with the content identifier includes:
causing display of a presentation of content that corresponds with the content identifier within a graphical user interface (GUI) of a client device;
determining a conclusion of a session performed by a user of the user account with respect to the content; and
causing display of a menu element based on the content, the menu element configured to receive the score as an input.

10. A method comprising:
receiving a score that corresponds with a content identifier from a user account, the score comprising at least a value that comprises an attribute;
accessing a user profile associated with the user account, the user profile indicating a cohort associated with the user account;
identifying a set of scores within a leaderboard associated with the content identifier based on the cohort associated with the user account;
determining a first ranking of the score associated with the user account among a portion of the set of scores based on at least the attribute of the score; and
determining a second ranking of the user account among a subset of the portion of the set of scores based on the value of the score.

11. The method of claim 10, further comprising:
causing display of a presentation of an identifier associated with the user account based on the first ranking and the second ranking.

12. The method of claim 11, wherein the presentation of the identifier based on the first ranking and the second ranking includes a display of the subset of the set of scores at a first position among the set of scores based on the first ranking, and wherein the identifier is presented at a second position among the subset of the portion of the set of scores based on the second ranking.

13. The method of claim 10, wherein the receiving the score includes:
receiving an input from a client device associated with the user account, wherein the input comprises the score.

14. The method of claim 10, wherein the value includes a numerical value, and wherein the attribute includes a temporal value.

15. The method of claim 10, wherein the receiving the score includes:
receiving a selection of the content identifier from among a set of content identifiers;
causing display of an input field to receive the input responsive to the selection of the content identifier; and
receiving an input that comprises the score via the input field.

16. The method of claim 15, wherein the input field is selected from among a plurality of input fields based on the content identifier.

17. The method of claim 10, wherein the accessing the user profile that indicates the cohort associated with the user account includes:
receiving a set of ranking indicia from a client device associated with the user account; and
assigning the user account to the cohort based on the ranking indicia.

18. The method of claim 10, wherein the receiving the score that corresponds with the content identifier includes:
causing display of a presentation of content that corresponds with the content identifier within a graphical user interface (GUI) of a client device;
determining a conclusion of a session performed by a user of the user account with respect to the content; and
causing display of a menu element based on the content, the menu element configured to receive the score as an input.

19. A non-transitory machine-readable storage medium comprising instructions that, when executed by one or more processors of a machine, cause the machine to perform operations comprising:
receiving a score that corresponds with a content identifier from a user account, the score comprising at least a value that comprises an attribute;
accessing a user profile associated with the user account, the user profile indicating a cohort associated with the user account;
identifying a set of scores within a leaderboard associated with the content identifier based on the cohort associated with the user account;
determining a first ranking of the score associated with the user account among a portion of the set of scores based on at least the attribute of the score; and
determining a second ranking of the user account among a subset of the portion of the set of scores based on the value of the score.

20. The non-transitory machine-readable storage medium of claim 19, further comprising:
causing display of a presentation of an identifier associated with the user account based on the first ranking and the second ranking.
